(19) United States
(12) Patent Application Publication
(10) Pub. No.: US 2008/0136758 A1
(43) Pub. Date: Jun. 12, 2008

(54) DISPLAY DEVICE

(75) Inventors: Eiji Ohta, Miyagi (JP); Toru Abiko, Miyagi (JP); Masato Ishigaki, Miyagi (JP); Satoshi Sato, Miyagi (JP); Shigehiro Yamakita, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/946,568

(22) Filed: Nov. 28, 2007

(30) Foreign Application Priority Data
Dec. 6, 2006 (JP) 2006-330044

(51) Int. Cl. G09G 3/36

(52) U.S. Cl. 345/87

(57) ABSTRACT

A display device is provided. The display device includes: a panel driven according to a video signal; a light source configured to emit light for illuminating the panel; a lens sheet disposed between the panel and the light source; and driving means for driving the panel. The lens sheet is formed by arranging a plurality of three-dimensional structures extending on one plane along an extending direction of the structures. A width of the three-dimensional structures in an arrangement direction is 110 μm or more. The panel has a pixel arrangement such that subpixels of a plurality of colors are arranged within one pixel and such that a plurality of subpixels of a same color are arranged within one pixel. The driving means drives the panel such that light and shade occur in a plurality of subpixels of a same color included in one pixel of pixels having at least a low gradation.

### CROSS REFERENCES TO RELATED APPLICATIONS

The present application claims priority to Japanese Patent Application JP 2006-330044 filed with the Japan Patent Office on Dec. 6, 2006, the entire contents of which is being incorporated herein by reference.

### BACKGROUND

The present application relates to a display device including an optically transparent lens sheet.

Liquid crystal display devices have recently been superseding cathode ray tubes (CRTs), which have been the mainstream of display devices in the past, because the liquid crystal display device has advantages such as low power consumption, space savings, and the like, and is reduced in price, for example. When the liquid crystal display device is classified according to methods of illumination when an image is displayed, for example, there are several types of liquid crystal display devices. A typical liquid crystal display device is a transmissive type display device that displays an image using a surface emitting light source disposed at the rear of a liquid crystal panel.

With such a transmissive type display device, it is particularly important to heighten display luminance in increasing the product value of the display device. Accordingly, a lens sheet for improving display luminance has been in the past disposed between a surface emitting light source and a liquid crystal panel. Thereby, diffused light emitted from the surface emitting light source is condensed by the lens sheet, so that front luminance is increased.

The lens sheet is thus used to heighten the display luminance of the display device. However, a periodic fringe pattern (moiré) may appear on the surface of the liquid crystal panel as a result of mutual interference between a regular repetitive pattern formed by prisms constituting the lens sheet and a regular repetitive pattern formed by a combination of subpixels constituting each pixel of the liquid crystal panel. Accordingly, a provision is made by reducing a lens pitch to 50 μm or 25 μm so as to narrow the width of moiré fringes with respect to the pitch of a pattern occurring on the liquid crystal panel side (U.S. Pat. No. 6,091,547, referred to as Patent Document 1).

Even when the lens pitch is reduced to 50 μm or 25 μm, a periodic moiré can occur as a result of occurrence of interference depending on a relation between the pitch of the liquid crystal panel and the lens pitch. Accordingly, in such a case, a provision is made by placing a diffusive sheet between the lens sheet and the liquid crystal panel, or performing matte processing on the back surface of the lens sheet to adjust the distribution of emitted light, for example. Further, a slightly diffusive filler is applied and formed as an antiglare layer on the front surface of the liquid crystal panel to suppress surface reflection, a slightly diffusive filler for preventing rubbing or close adhesion between the back surface of the liquid crystal panel and an optical sheet is applied and formed on the back surface of the liquid crystal panel, and frosting processing is performed, so that a moiré occurring between the lens sheet and the liquid crystal panel is reduced.

However, thus decreasing the lens pitch results in an increase in a ratio of apical parts and valley parts that do not contribute to the raising of the luminance to inclined plane parts contributing to the raising of the luminance, so that the luminance may not be raised sufficiently in the lens sheet. In addition, the slightly diffusive fillers used in the antiglare processing on the front of the liquid crystal panel and in the frosting processing on the back surface of the liquid crystal panel, for example, diffuse light emitted in the direction of the front, thus inviting a decrease in luminance.

### SUMMARY

The present application has been made in view of such problems. It is desirable to provide a display device that can render a moiré inconspicuous without decreasing the luminance by reducing the pitch of the lens sheet or without performing the antiglare processing or the frosting processing, which invite a decrease in front luminance, on the front and the back of the liquid crystal panel.

A display device according to a first embodiment includes: a panel driven according to a video signal; a light source configured to emit light for illuminating the panel; and driving means for driving the panel. A lens sheet formed by arranging a plurality of three-dimensional structures extending on one plane along an extending direction of the plurality of three-dimensional structures is disposed between the panel and the light source. The width of the three-dimensional structures in an arrangement direction is 110 μm or more. The panel has a pixel arrangement such that subpixels of a plurality of colors are arranged within one pixel and such that a plurality of subpixels of a same color are arranged within the one pixel. The driving means drives the panel such that light and shade occur in the plurality of pixels of the same color included in the one pixel.

In the display device according to the first embodiment, the driving means drives the panel such that light and shade occur in the plurality of pixels of the same color included in the one pixel. Thus, even when the width of the three-dimensional structures in the arrangement direction is 110 μm or more, a regular repetitive pattern formed by prisms constituting the lens sheet and a regular repetitive pattern formed by a combination of subpixels constituting each pixel of the panel hardly interfere with each other.

A display device according to a second embodiment includes: a panel driven according to a video signal; a light source configured to emit light for illuminating the panel; and driving means for driving the panel. A lens sheet formed by arranging a plurality of three-dimensional structures extending on one plane along an extending direction of the plurality of three-dimensional structures is disposed between the panel and the light source. The width of the three-dimensional structures in an arrangement direction is 110 μm or more. The panel has a pixel arrangement such that subpixels of a plurality of colors are arranged so as to form a diagonal arrangement, a delta arrangement, or a rectangle arrangement.

The diagonal arrangement refers to for example an arrangement formed by arranging square filters of respective colors in an oblique direction for each color and periodically arranging the filters of the respective colors along an arrangement direction. The delta arrangement refers to for example an arrangement formed by periodically arranging square filters of respective colors in a linear manner in one direction and arranging the filters of the respective colors such that the filters of the respective colors are arranged in a zigzag manner in a direction orthogonal to the one direction and filters of a same color are not adjacent to each other. The rectangle arrangement refers to for example an arrangement formed by arranging a plurality of unit constitutions each obtained by combining four square filters into a square form in one direction and also arranging a plurality of unit constitutions in a direction orthogonal to the one direction, two filters of the four filters included in a unit constitution being formed in a same color, the two other filters being formed in colors different from each other, and the two filters of the same color being arranged on a diagonal line so as not to be adjacent to each other.

In the display device according to the second embodiment, the panel has a pixel arrangement such that subpixels of a plurality of colors are arranged so as to form a diagonal arrangement, a delta arrangement, or a rectangle arrangement. Thus, even when the width of the three-dimensional structures in the arrangement direction is 110 μm or more, a regular repetitive pattern formed by prisms constituting the lens sheet and a regular repetitive pattern formed by a combination of subpixels constituting each pixel of the panel hardly interfere with each other.

In accordance with the display device according to the first embodiment, the driving means is used to drive the panel such that light and shade occur in a plurality of subpixels of a same color included in one pixel. Thus, when the width of the three-dimensional structures in the arrangement direction is 110 μm or more, it is possible to render a moiré inconspicuous without decreasing luminance by reducing the pitch of the lens sheet or without performing the antiglare processing or the frosting processing, which invite a decrease in front luminance, on the front and the back of the liquid crystal panel.

In accordance with the display device according to the second embodiment, the panel has a pixel arrangement such that subpixels of a plurality of colors are arranged so as to form a diagonal arrangement, a delta arrangement, or a rectangle arrangement. Thus, when the width of the three-dimensional structures in the arrangement direction is 110 μm or more, it is possible to render a moiré inconspicuous without decreasing luminance by reducing the pitch of the lens sheet or without performing the antiglare processing or the frosting processing, which invite a decrease in front luminance, on the front and the back of the liquid crystal panel.

Additional features and advantages are described herein, and will be apparent from, the following Detailed Description and the figures.

### BRIEF DESCRIPTION OF THE FIGURES

FIG. 1 is a functional block diagram of a display device according to an embodiment;

FIG. 2 is a sectional view of an example of configuration of an illuminating device and a liquid crystal panel in FIG. 1;

FIG. 3 is a sectional view of an example of configuration of a light source image dividing sheet in FIG. 2;

FIG. 4 is a sectional view of an example of configuration of a lens film in FIG. 2;

FIG. 5 is a relational diagram of assistance in explaining a relation between the pitch of the lens film in FIG. 2 and front luminance;

FIG. 6 is a schematic configuration diagram of assistance in explaining a stripe arrangement;

FIG. 7 is a schematic configuration diagram of assistance in explaining a diagonal arrangement;

FIG. 8 is a schematic configuration diagram of assistance in explaining a delta arrangement;

FIG. 9 is a schematic configuration diagram of assistance in explaining a rectangle arrangement;

FIG. 10 is a schematic configuration diagram of assistance in explaining a method of introducing subcells without changing an area per pixel;

FIGS. 11A and 11B are schematic configuration diagrams of assistance in explaining an example of modification of FIG. 10;

FIG. 12 is a schematic configuration diagram of assistance in explaining a method of changing an area per pixel and introducing subcells;

FIGS. 13A and 13B are schematic configuration diagrams of assistance in explaining an example of modification of FIG. 12;

FIG. 14 is a schematic configuration diagram of assistance in explaining a method of greatly changing an area per pixel and introducing subcells; and

FIGS. 15A and 15B are schematic configuration diagrams of assistance in explaining an example of modification of FIG. 14.

### DETAILED DESCRIPTION

Embodiments of the present application will be described below in detail with reference to the drawings.

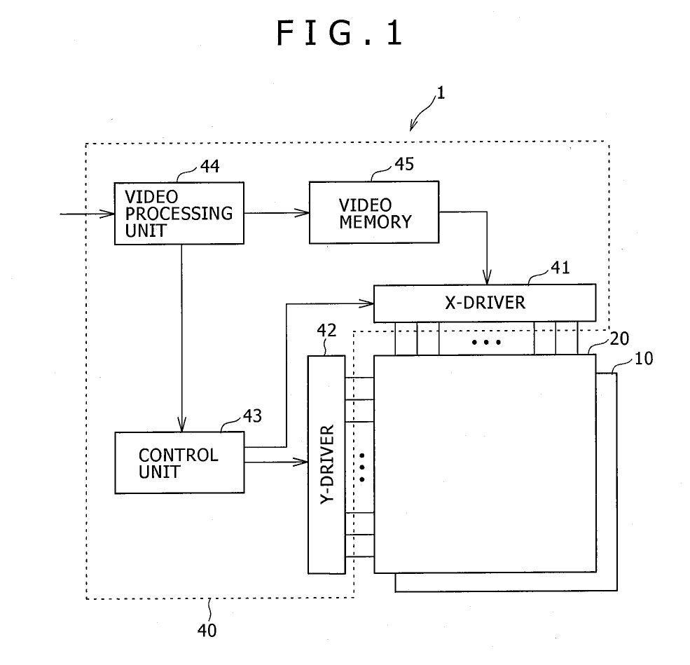

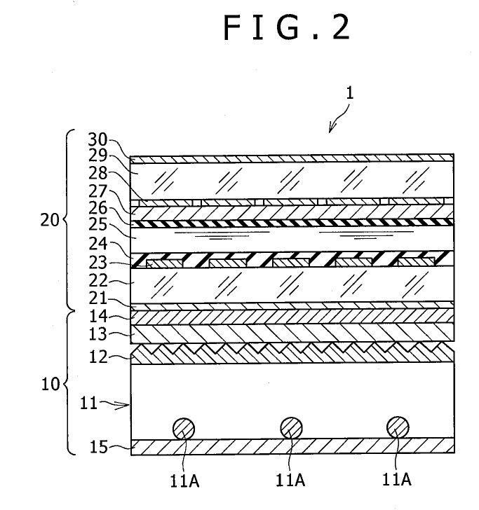

FIG. 1 shows functional blocks of a display device 1 according to an embodiment. This display device 1 includes: a transmissive type liquid crystal panel 20 in which each pixel is driven according to a video signal; an illuminating device 10 disposed at the rear of the liquid crystal panel 20; and a driving circuit 40 for driving the liquid crystal panel 20 to display video. The surface of the liquid crystal panel 20 is faced to an observer (not shown) side. Incidentally, in the present embodiment, suppose for convenience that the liquid crystal panel 20 is disposed such that the surface of the liquid crystal panel 20 is orthogonal to a horizontal plane. FIG. 2 shows a sectional structure of the illuminating device 10 and the liquid crystal panel 20 laminated to each other.

The illuminating device 10 has a light source 11. On the liquid crystal panel 20 side of the light source 11, a light source image dividing sheet 12, a diffusing sheet 13, and a lens sheet 14 are disposed in this order from the light source 11 side. On the other hand, a reflecting sheet 15 is disposed at the rear of the light source 11. Thus, the illuminating device 10 has the constitution of a so-called direct backlight.

The light source 11 is formed by arranging a plurality of linear light sources 11A in parallel with each other at equal intervals (for example intervals of 20 μm). The linear light sources 11A are typically cold cathode fluorescent lamps (CCFLs) referred to as cold cathode tubes. However, the linear light sources 11A may be formed by linearly arranging dot-shaped light sources such as light emitting diodes (LEDs), organic EL (Electro-Luminescence) devices, or the like. Each of the linear light sources 11A is for example disposed in such a manner as to extend in a horizontal direction (a direction perpendicular to the paper surface of FIG. 2).

The reflecting sheet 15 is for example formed by laminating aluminum (Al), foamed PET (polyethylene terephthalate), and polycarbonate in this order from the light source 11 side. The reflecting sheet 15 reflects a part of light emitted from the light source 11 in the direction of the liquid crystal panel 20. Thereby the light emitted from the light source 11 can be used efficiently.

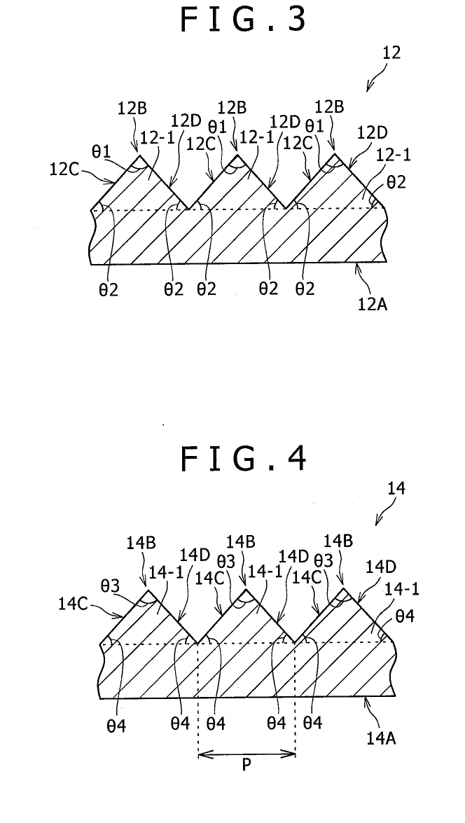

The light source image dividing sheet 12 is for example formed by a transparent synthetic resin. In consideration of cost, productivity and the like, it is desirable that the light source image dividing sheet 12 be formed by a thermoplastic resin such as a polycarbonate base resin or the like. The light source image dividing sheet 12 is disposed such that the bottom surface 12A of the light source image dividing sheet 12 is parallel with the surface of the liquid crystal panel 20. As shown in FIG. 3, which is an enlarged view of an example of the section of the light source image dividing sheet 12, a plurality of column-shaped prisms 12-1 extending along a plane parallel with the bottom surface 12A of the light source image dividing sheet 12 are continuously arranged in parallel with each other on a surface on the liquid crystal panel 20 side of the light source image dividing sheet 12. In this case, it is desirable that each of the prisms 12-1 be disposed such that the extending direction of each of the prisms 12-1 is parallel with the extending direction of each of the linear light sources 11A (for example the horizontal direction). However, each of the prisms 12-1 may be disposed such that each of the prisms 12-1 intersects with the extending direction of each of the linear light sources 11A within a range allowable from a viewpoint of optical characteristics. Each of the prisms 12-1 has for example the shape of a triangular prism with inclined planes 12C and 12D touching an apical part 12B with an apical angle θ1. The inclined planes 12C and 12D are disposed in such a manner as to be obliquely opposed to the bottom surface 12A at a base angle θ2.

Thus, the light source image dividing sheet 12 emits light incident on the bottom surface 12A or the inclined planes 12C and 12D at an angle smaller than a critical angle, which incident light is a part of light emitted from one linear light source 11A, to the liquid crystal panel 20 side, while the light source image dividing sheet 12 performs total reflection of light incident at an angle equal to or larger than the critical angle. The light source image dividing sheet 12 therefore has a function of dividing a light source image produced by one linear light source 11A into a plurality of light source images. That is, the light source image dividing sheet 12 divides a light source image produced by one linear light source 11A into a plurality of light source images to make intervals of the light source images formed from each light source image after the division shorter than intervals between the linear light sources 11A. The light source image dividing sheet 12 thus renders a difference between a luminance level of the light source images after the division (maximum value) and a luminance level between the light source images after the division (minimum value) smaller than a difference between a luminance level of the light source images before the division (maximum value) and a luminance level between the light source images before the division (minimum value). Thereby the nonuniformity of illumination luminance can be reduced. Thus the light source image dividing sheet 12 can also be said to be one kind of diffusing sheet.

The diffusing sheet 13 is for example a diffusing plate formed by distributing a diffusing material (filler) within a relatively thick plate-shaped transparent resin, a diffusing film formed by coating the surface of a relatively thin film-shaped transparent resin with a transparent resin including a diffusing material, or a combination of the diffusing plate and the diffusing film. PET, acrylic, and polycarbonate, for example, are used for the plate-shaped or film-shaped transparent resin. The diffusing sheet 13 thus has a function of diffusing the light source images produced by the light source image dividing sheet 12.

As with the light source image dividing sheet 12, the lens sheet 14 is for example formed of a transparent synthetic resin. The lens sheet 14 is disposed such that the bottom surface 14A of the lens sheet 14 is parallel with the surface of the liquid crystal panel 20. As shown in FIG. 4, which is an enlarged view of an example of the section of the lens sheet 14, a plurality of column-shaped prisms 14-1 (three-dimensional structure) extending along a plane parallel with the bottom surface 14A of the lens sheet 14 are continuously arranged in an extending direction on a surface on the liquid crystal panel 20 side of the lens sheet 14. In this case, it is desirable that each of the prisms 14-1 be disposed such that the extending direction of each of the prisms 14-1 is orthogonal to the extending direction of each of the prisms 12-1 of the light source image dividing sheet 12 (for example the horizontal direction). However, each of the prisms 14-1 may be disposed such that each of the prisms 14-1 intersects with the extending direction of each of the prisms 12-1 within a range allowable from a viewpoint of optical characteristics. Each of the prisms 14-1 has for example the shape of a triangular prism with inclined planes 14C and 14D touching an apical part 14B with an apical angle θ3. The inclined planes 14C and 14D are disposed in such a manner as to be obliquely opposed to the bottom surface 14A at a base angle θ4. At this time, the width (a pitch Pw in the lens sheet 14) of each of the prisms 14-1 is 110 μm or more.

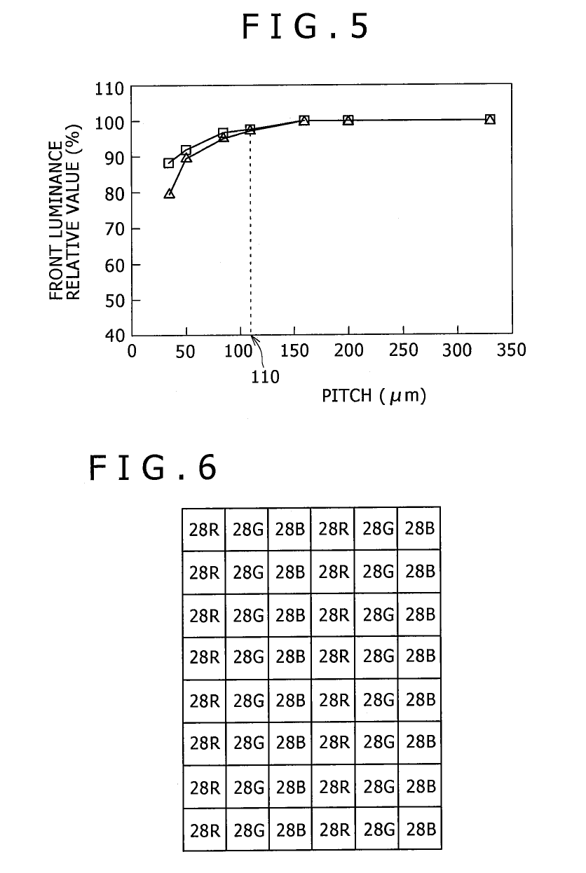

As shown in FIG. 5, by setting the pitch Pw of each of the prisms 14-1 at 110 μm or more, it is possible to maximize front luminance. A solid line in FIG. 5 represents a relation between the pitch and relative luminance when each of the prisms 14-1 is in the shape of a prism. A broken line in FIG. 5 represents a relation between the pitch and relative luminance when each of the prisms 14-1 has a hyperboloidal shape. It is indicated that with any shape of each of the prisms 14-1, the front luminance can be improved by setting the pitch at 110 μm or more as long as each of the prisms 14-1 has a geometrical shape that can improve the luminance. Incidentally, when the pitch P of each of the prisms 14-1 exceeds 500 μm, the height (thickness) of each of the prisms 14-1 is increased, so that the thickness of a base material part on which each of the prisms 14-1 is formed may also have to be increased.

Incidentally, each of the prisms 14-1 may for example be in a semicylindrical shape having a hyperboloid in a direction orthogonal to the extending direction of the prisms 14-1. In addition, each of the prisms 14-1 does not have to have an identical shape. For example, two column-shaped prisms having shapes different from each other may be set as a unit structure, and such unit structures may be continuously arranged in parallel with each other along the extending direction. In this case, the width of a unit structure is the pitch in the lens sheet 14.

Thus, the lens sheet 14 refracts and transmits, in a direction orthogonal to the liquid crystal panel 20, a component of the light diffused by the diffusing sheet 13 which component is in a direction orthogonal to the extending direction of each of the prisms 14-1 (for example the horizontal direction). Thereby directivity is increased. Incidentally, the lens sheet 14 does not produce a light condensing effect of the refracting action of each of the prisms 14-1 on a component of the light diffused by the diffusing sheet 13 which component is in the extending direction of each of the prisms 14-1 (for example a vertical direction). The light transmitted by the lens sheet 14 therefore provides a wide viewing angle in the extending direction of each of the prisms 14-1 (vertical viewing angle, for example) and a narrow viewing angle in the direction orthogonal to the extending direction of each of the prisms 14-1 (horizontal viewing angle, for example).

The liquid crystal panel 20 is of a laminated structure having a liquid crystal layer 25 between a transparent substrate 29 on the observation side and a transparent substrate 22 on the illuminating device 10 side. Specifically, the liquid crystal panel 20 has a polarizer 21, the transparent substrate 22, transparent electrodes 23, an alignment film 24, the liquid crystal layer 25, an alignment film 26, a transparent electrode 27, a color filter 28, the transparent substrate 29, and a polarizer 30 in this order from the illuminating device 10 side.

The polarizers 21 and 30 are a kind of optical shutter. The polarizers 21 and 30 pass only light (polarized light) in a certain vibrating direction. The polarizers 21 and 30 are disposed such that the respective polarizing axes of the polarizers 21 and 30 differ from each other by 90 degrees. The light emitted from the illuminating device 10 is thereby transmitted via the liquid crystal layer 25 or blocked.

The transparent substrates 22 and 29 are formed by a substrate that is transparent to visible light, for example a plate glass. Incidentally, though not shown in the figure, an active type driving circuit including a TFT (Thin Film Transistor) as a driving element electrically connected to the transparent pixel electrode 23, wiring, and the like is formed on the transparent substrate 22 on the illuminating device 10 side.

The transparent electrodes 23 and 27 are for example formed by ITO (Indium Tin Oxide). The transparent electrodes 23 are arranged in a lattice arrangement or a delta arrangement on the transparent substrate 22. The transparent electrodes 23 function as electrodes for each dot (pixel). On the other hand, the transparent electrode 27 is formed as one plane on the color filter 28. The transparent electrode 27 functions as a common electrode opposed to each of the transparent electrodes 23.

The alignment films 24 and 26 are formed of a high polymer material such as a polyimide, for example. The alignment films 24 and 26 perform an alignment process on a liquid crystal.

The liquid crystal layer 25 is for example formed by a liquid crystal in a VA (Vertical Alignment) mode, a TN (Twisted Nematic) mode, or an STN (Super Twisted Nematic) mode. As will be described later, the liquid crystal layer 25 has a modulating function for transmitting or blocking the light emitted from the illuminating device 10 for each pixel according to a voltage applied from the driving circuit 40. Incidentally, the gradation of each pixel is adjusted by changing the light transmission level of the liquid crystal.

The color filter 28 is formed by arranging color filters for separating the light passed through the liquid crystal layer 25 into for example three primary colors of red (R), green (G), and blue (B), or four colors of R, G, B, and white (W), for example, in correspondence with the arrangement of the transparent electrodes 23. The filter arrangement (pixel arrangement) typically includes a stripe arrangement, a diagonal arrangement, a delta arrangement, and a rectangle arrangement.

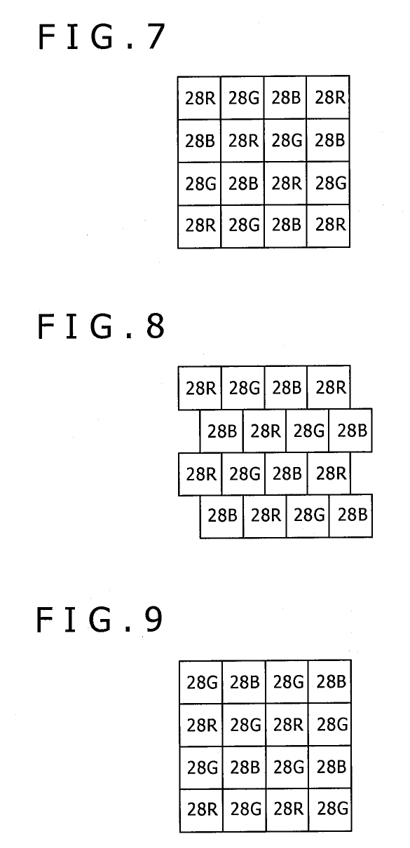

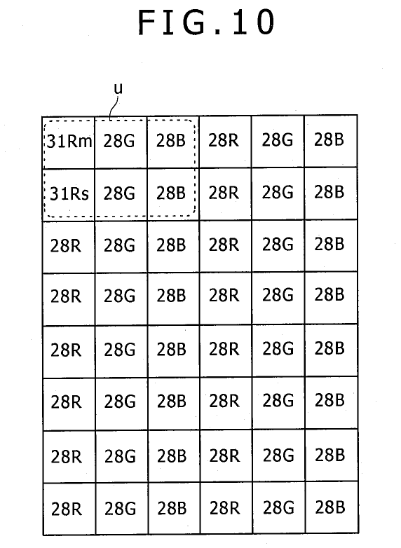

As illustrated in FIG. 6, the stripe arrangement is formed by arranging square filters 28R, 28G, and 28B of the respective colors in one direction (the vertical direction of the paper surface of FIG. 6) for each color and periodically arranging the filters 28R, 28G, and 28B of the respective colors along one direction. As illustrated in FIG. 7, the diagonal arrangement is formed by arranging square filters 28R, 28G, and 28G of the respective colors in an oblique direction (an oblique 45° direction in FIG. 7) for each color and periodically arranging the filters 28R, 28G, and 28B of the respective colors along an arrangement direction. As illustrated in FIG. 8, the delta arrangement is formed by periodically arranging square filters 28R, 28G, and 28B of the respective colors in a linear manner in one direction (the horizontal direction of the paper surface of FIG. 8) and arranging the filters 28R, 28G, and 28B of the respective colors such that the filters 28R, 28G, and 28B of the respective colors are arranged in a zigzag manner in a direction (the vertical direction of the paper surface of FIG. 8) orthogonal to the one direction and filters of the same color are not adjacent to each other. As illustrated in FIG. 9, the rectangle arrangement is formed by arranging a plurality of unit constitutions 28U each obtained by combining four square filters into a square form in one direction (the horizontal direction of the paper surface of FIG. 9) and also arranging a plurality of unit constitutions 28U in a direction (the vertical direction of the paper surface of FIG. 9) orthogonal to the one direction. Two filters (filters 28G and 28G in FIG. 9) of the four filters included in a unit constitution are formed in the same color, the two other filters (filters 28R and 28B in FIG. 9) are formed in colors different from each other, and the two filters of the same color are arranged on a diagonal line so as not to be adjacent to each other.

In the diagonal arrangement, the delta arrangement, and the rectangle arrangement of the above-described filter arrangements, filters of the same color are not adjacent to each other, and therefore the combination of subpixels forming each pixel (pixel arrangement) is not determined uniquely and varies widely in a complex manner. In the stripe arrangement, on the other hand, filters of the same color are adjacent to each other in the extending direction of stripes, and therefore the combination of subpixels forming each pixel is determined substantially uniquely. Incidentally, the present embodiment adopts a pixel arrangement in which subpixels of a plurality of colors are arranged within one pixel and a plurality of subpixels of the same color are arranged within one pixel.

The driving circuit 40 includes: an X-driver (data driver) 41 for supplying a driving voltage based on a video signal to each of the transparent electrodes 23 within the liquid crystal panel 20; a Y-driver (gate driver) 42 for sequentially driving the transparent electrode 27 within the liquid crystal panel 20 along scanning lines not shown in the figure; a control unit 43 for controlling the X-driver 41 and the Y-driver 42; a video processing unit 44 for processing the external video signal and thereby generating an RGB signal; and a video memory 45 as a frame memory for storing the RGB signal from the video processing unit 44.

The video processing unit 44 performs the following processing when the color filter 28 has a filter arrangement such that the combination of subpixels forming each pixel is determined substantially uniquely, and when the video signal includes a non-high gradation signal such that display luminance is a low gradation or an intermediate gradation. The following processing does not have to be performed when the combination of subpixels forming each pixel varies widely in a complex manner. Incidentally, description will be made in the following by illustrating a case where the color filter 28 has the filter arrangement of FIG. 6 and one pixel u (see FIG. 10) is formed by two Rs, two Gs, and two Bs when display luminance is a high gradation.

Generally, driving voltages obtained from an R signal, a G signal, and a B signal included in an RGB signal are applied to respective transparent electrodes 23 within the liquid crystal panel 20. The respective values of the R signal, the G signal, and the B signal are therefore in correspondence with display luminances in subpixels to which to input the R signal, the G signal, and the B signal. Accordingly, let Ar, Ag, and Ab be the display luminances of the respective colors included in one pixel when there is such a correspondence.

First, the video processing unit 44 determines whether the RGB signal corresponds to a non-high gradation signal. When the RGB signal corresponds to a non-high gradation signal, the video processing unit 44 corrects at least one of the R signal, the G signal, and the B signal included in the RGB signal.

When the correction is to be performed without an area per pixel being changed, and when only the R signal is to be corrected, for example, as shown in FIG. 10, one of subpixels 31R for R to which to input the R signal is set as a main cell 31Rm, and the other is set as a subcell 31Rs. Then, the display luminance of the main cell 31m is made higher than the display luminance of the subcell 31Rs, and the display luminance of the subcell 31Rs is made lower than the display luminance of the main cell 31Rm, such that the display luminance (average luminance) obtained by the main cell 31m and the subcell 31Rs becomes the display luminance Ar. That is, light and shade are provided in the same color within one pixel. At this time, it is desirable that main cells 31Rm in respective pixels adjacent to each other not be adjacent to each other and that subcells 31Rs in the respective pixels adjacent to each other not be adjacent to each other. That is, in display pixels, it is desirable that main cells 31Rm corresponding to light in a plurality of subpixels of the same color included in the pixels are arranged alternately with subcells 31Rs corresponding to shade in the plurality of subpixels of the same color included in the pixels. Incidentally, the individual values of R signals corresponding to the main cells 31Rm (values after the correction) and the individual values of R signals corresponding to the subcells 31Rs (values after the correction) at this time are not in correspondence with the display luminance obtained from the R signal before the correction.

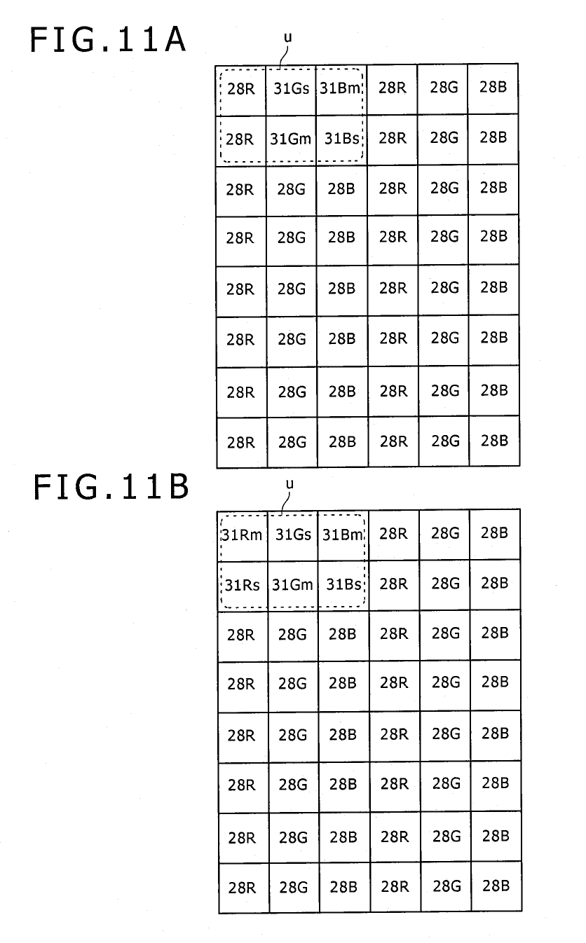

Incidentally, the object of the correction is not limited to this. For example, one of two subpixels included in one of two kinds of subpixels to which to input the G signal or the B signal may be set as a main cell, and the other may be set as a subcell. Then, only the G signal or the B signal may be corrected. In addition, for example, one of two subpixels included in each of two kinds of subpixels (31G and 31B in FIG. 11A) to which to input at least two of the R signal, the G signal, and the B signal may be set as a main cell (31Gm and 31Bm in FIG. 11A), and the other may be set as a subcell (31Gs and 31Bs in FIG. 11A). Then, at least two (the G signal and the B signal in FIG. 11A) of the R signal, the G signal, and the B signal may be corrected. Further, all of the R signal, the G signal, and the B signal may be corrected, as shown in FIG. 11B.

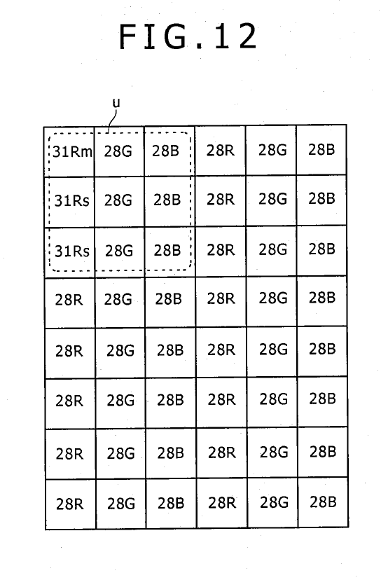

In a case where the correction is to be performed with an area per pixel changed, as shown in FIG. 12, for example, when the number of subpixels forming one pixel is increased from six to 10 and the number of subpixels for each color is increased from two to three in a region where display luminance is a low gradation or an intermediate gradation, one of three subpixels to which to input respective R signals is set as a main cell 31m, and the other two are set as subcells 31s. Then, the display luminance of the main cell 31m is made higher than the display luminance of the subcells 31s, and the display luminance of the subcells 31s is made lower than the display luminance of the main cell 31m, such that the display luminance (average luminance) obtained by the main cell 31m and the subcells 31s becomes the display luminance Ar. That is, as in the above, light and shade are provided in the same color within one pixel. At this time, as in the above, it is desirable that main cells 31Rm in respective pixels adjacent to each other not be adjacent to each other and that subcells 31Rs in the respective pixels adjacent to each other not be adjacent to each other.

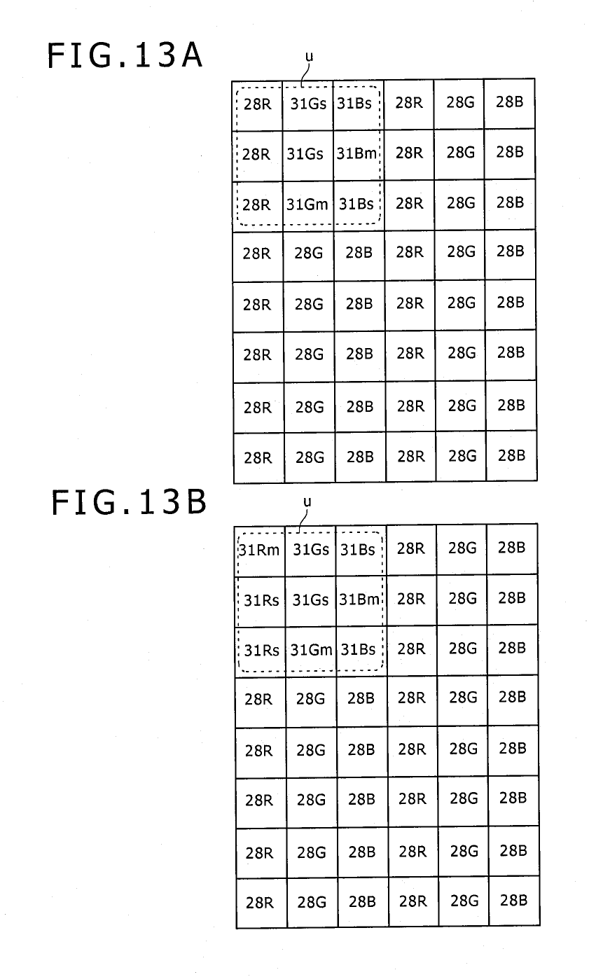

Incidentally, the object of the correction is not limited to this. For example, one of three subpixels included in one of two kinds of subpixels to which to input the G signal or the B signal may be set as a main cell, and the other two may be set as subcells. Then, only the G signal or the B signal may be corrected. In addition, one of three subpixels included in each of two kinds of subpixels (31G and 31B in FIG. 13A) to which to input at least two of the R signal, the G signal, and the B signal may be set as a main cell (31Gm and 31Bm in FIG. 13A), and the other two may be set as a subcell (31Gs and 31Bs in FIG. 13A). Then, at least two (the G signal and the B signal in FIG. 13A) of the R signal, the G signal, and the B signal may be corrected. Further, all of the R signal, the G signal, and the B signal may be corrected, as shown in FIG. 13B. Further, the number of main cells 31m may be two, and the number of subcells 31s may be one.

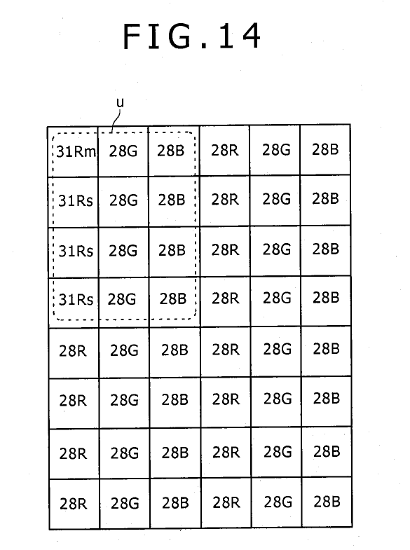

In a case where the correction is to be performed with an area per pixel changed more drastically than in the above case, as shown in FIG. 14, for example, when the number of subpixels forming one pixel is increased from six to 12 and the number of subpixels for each color is increased from two to four in a region where display luminance is a low gradation or an intermediate gradation, one of four subpixels to which to input respective R signals is set as a main cell 31m, and the other three are set as subcells 31s. Then, the display luminance of the main cell 31m is made higher than the display luminance of the subcells 31s, and the display luminance of the subcells 31s is made lower than the display luminance of the main cell 31m, such that the display luminance (average luminance) obtained by the main cell 31m and the subcells 31s becomes the display luminance Ar. That is, as in the above, light and shade are provided in the same color within one pixel. At this time, as in the above, it is desirable that main cells 31Rm in respective pixels adjacent to each other not be adjacent to each other and that subcells 31Rs in the respective pixels adjacent to each other not be adjacent to each other.

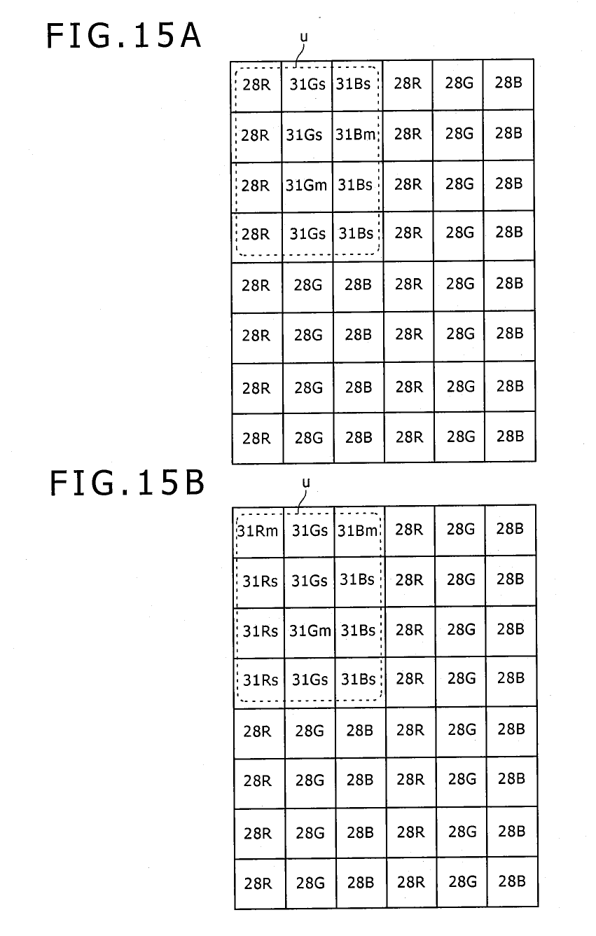

Incidentally, the object of the correction is not limited to this. For example, one of four subpixels included in one of two kinds of subpixels to which to input the G signal or the B signal may be set as a main cell, and the other three may be set as subcells. Then, only the G signal or the B signal may be corrected. In addition, one of four subpixels included in each of two kinds of subpixels (31G and 31B in FIG. 15A) to which to input at least two of the R signal, the G signal, and the B signal may be set as a main cell (31Gm and 31Bm in FIG. 15A), and the other three may be set as a subcell (31Gs and 31Bs in FIG. 15A). Then, at least two (the G signal and the B signal in FIG. 15A) of the R signal, the G signal, and the B signal may be corrected. Further, all of the R signal, the G signal, and the B signal may be corrected, as shown in FIG. 15B. Further, the number of main cells 31m may be two, and the number of subcells 31s may be two. Alternatively, the number of main cells 31m may be three, and the number of subcells 31s may be one.

Description will next be made of a basic operation when the display device 1 including the thus formed lens films 12 and 13 makes an image display.

First, in the illuminating device 10, the light source image dividing sheet 12 divides light emitted from the light source 11 into minute luminous fluxes, the diffusing sheet 13 diffuses light source images obtained by the division, and after the lens sheet 14 increases directivity, resulting light is emitted to the liquid crystal panel 20.

Then, the liquid crystal panel 20 transmits the incident light from the illuminating device 10 according to the magnitude of a voltage applied for each pixel between the transparent electrode 23 and the transparent electrode 27 as counter electrode, separates the transmitted light into colors by the color filter 28, and then emits a resulting image to the observation side. Thereby a color image display is made.

As described above, when the color filter 28 has a filter arrangement (for example a stripe arrangement) in which a pixel arrangement is determined substantially uniquely, there is a possibility of a periodic fringe pattern (moiré) appearing on the surface of the liquid crystal panel 20 as a result of mutual interference between a regular repetitive pattern formed by a combination of subpixels constituting each pixel and a regular repetitive pattern formed by the prisms 14-1 constituting the lens sheet 14 as an optical part disposed nearest to the liquid crystal panel 20.

In addition, when the optical part disposed nearest to the liquid crystal panel 20 has a periodic structure, and the pitch of the periodic structure is greater than about 100 μm, there is a possibility of a periodic fringe pattern (moiré) appearing on the surface of the liquid crystal panel 20 as in the above.

For example, as shown in Table 1, when all the pixels are set at a same luminance, and the luminance level is gradually degreased to 80%, 60%, 40%, and 20% with a maximum luminance being 100%, at a pitch of 80 μm and luminance levels of 40% and 20%, a moiré having a width of about 2 mm was visually recognized. At a pitch of 160 μm and luminance levels of 60%, 40%, and 20%, a moiré having a width of about 2 mm was visually recognized. At a pitch of 185 μm and luminance levels of 60%, 40%, and 20%, a moiré having a width exceeding 2 mm was visually recognized clearly. At a pitch of 200 μm and luminance levels of 60%, 40%, and 20%, a moiré having a width of about 2 mm was visually recognized. On the other hand, at a pitch of 50 μm, a moiré was not visually recognized at any luminance level. In Table 1, a white circle denotes that no moiré was visually recognized, a white triangle denotes that a moiré having a width of about 2 mm was visually recognized, and a cross denotes that a moiré having a width exceeding 2 mm was visually recognized clearly.

TABLE 1

| | WHITE LUMINANCE | | | | |
|---|---|---|---|---|---|
| PITCH P | 20% | 40% | 60% | 80% | 100% |
| 50 μm | ∘ | ∘ | ∘ | ∘ | ∘ |
| 80 μm | Δ | Δ | ∘ | ∘ | ∘ |
| 160 μm | Δ | Δ | Δ | ∘ | ∘ |
| 185 μm | x | x | x | ∘ | ∘ |
| 200 μm | Δ | Δ | Δ | ∘ | ∘ |

Accordingly, in the past, when the optical part disposed nearest to the liquid crystal panel 20 has a periodic structure, the pitch of the periodic structure is reduced to about 50 μm, or a diffusing sheet or the like without a periodic structure is provided between the optical part having the periodic structure and the liquid crystal panel 20, so that a moiré is made less conspicuous.

From Table 1, it can be said that the moiré has a characteristic of being hardly conspicuous in a region where the display luminance of the surface of the liquid crystal panel 20 is a high gradation but being conspicuous in a region where the display luminance is a low gradation or an intermediate gradation.

Accordingly, in the present embodiment, when the color filter 28 has a filter arrangement (for example a stripe arrangement) in which a pixel arrangement is determined substantially uniquely, in a region where the display luminance is a low gradation or an intermediate gradation, light and shade are provided in a same color within one pixel, or light and shade are provided in a same color within one pixel and the area of one pixel is increased.

For example, as shown in Table 2, when a pixel arrangement as illustrated in FIG. 10 was set and the luminance level was gradually degreased to 80%, 60%, 40%, and 20% with a maximum luminance being 100%, in a region where the display luminance was a low gradation or an intermediate gradation, no luminance variations were visually recognized in any case.

TABLE 2

| | WHITE LUMINANCE | | | | |
|---|---|---|---|---|---|
| PITCH P | 20% | 40% | 60% | 80% | 100% |
| 50 μm | ∘ | ∘ | ∘ | ∘ | ∘ |
| 80 μm | ∘ | ∘ | ∘ | ∘ | ∘ |
| 160 μm | ∘ | ∘ | ∘ | ∘ | ∘ |
| 185 μm | ∘ | ∘ | ∘ | ∘ | ∘ |
| 200 μm | ∘ | ∘ | ∘ | ∘ | ∘ |

Thus, even in a case where the pitch Pw of the prisms 14-1 forming the lens sheet 14 is set at 110 μm to 500 μm, a moiré is inconspicuous even if the moiré occurs in a high gradation region, and a moiré can be made inconspicuous in a non-high gradation region (a low gradation region and an intermediate gradation region).

The moiré occurs when one regular repetitive pattern and another regular repetitive pattern interfere with each other. Accordingly, in the present embodiment, when the method of display by the driving circuit 40 as described above is not used, the color filter 28 has a filter arrangement (for example the diagonal arrangement, the delta arrangement, and the rectangle arrangement) in which the combination of subpixels forming each pixel (pixel arrangement) varies widely in a complex manner. The moiré can therefore be made inconspicuous even when the pitch Pw of the prisms 14-1 forming the lens sheet 14 is set at 110 μm to 500 μm.

While the above description has been made by citing embodiments and examples, the present invention is not limited to these embodiments and the like, and various changes can be made.

For example, in the foregoing embodiment, description has been made of a case where the driving circuit 40 may increase an area per pixel (the number of subpixels included in one pixel) when an RGB signal corresponds to a non-high gradation signal, which case is applied to a case where an RGB signal corresponds to a high gradation signal. However, the area per pixel (the number of subpixels included in one pixel) may be increased as the gradation becomes lower. For example, a change can be made to a pixel arrangement as shown in FIG. 10 or FIGS. 11A and 11B when the RGB signal corresponds to a non-high gradation signal and the gradation is relatively high. A change can be made to a pixel arrangement as shown in FIG. 12 or FIGS. 13A and 13B when the gradation is slightly lower than in the above case. A change can be made to a pixel arrangement as shown in FIG. 14 or FIGS. 15A and 15B when the gradation is even lower than in the above case. When the pixel arrangement is thus changed, it is also possible to gradually change (increase) the number of subpixels included in one pixel (area per pixel) by changing (increasing) the number of subpixels of at least one color among subpixels of each color included in one pixel as the gradation becomes lower.

For example, while in the present embodiment, description has been made by citing a concrete composition of the display device 1, it is not necessary to provide all the layers, and another layer may be provided. For example, a diffusing sheet may be provided between the lens sheet 14 and the liquid crystal panel 20. That is, various selections can be made according to uses and objects.

In addition, while the linear light sources 11A are used as the light source 11 in the present embodiment, the light source 11 is not limited to this, and for example a light source formed by arranging dot-shaped light sources in the form of a matrix may be used.

In addition, the present application is applicable to various driving systems such as active matrix driving, simple matrix driving and the like.

Further, while in the present embodiment, description has been made of a case where the present application is applied to a liquid crystal display device, the present application is of course applicable to display devices using other principles.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device comprising:
a panel driven according to a video signal;
a light source configured to emit light for illuminating said panel;
a lens sheet disposed between said panel and said light source; and
driving means for driving said panel;
wherein said lens sheet is formed by arranging a plurality of three-dimensional structures extending on one plane along an extending direction of the plurality of three-dimensional structures,
a width of said three-dimensional structures in an arrangement direction is 110 μm or more,
said panel has a pixel arrangement such that subpixels of a plurality of colors are arranged within one pixel and such that a plurality of subpixels of a same color are arranged within one pixel, and
said driving means drives said panel such that light and shade occur in a plurality of subpixels of a same color included in one pixel of pixels having at least a low gradation.

2. The display device according to claim 1, wherein the width of said three-dimensional structures in the arrangement direction is 500 μm or less.

3. The display device according to claim 1, wherein said pixel arrangement is a stripe arrangement.

4. The display device according to claim 1, wherein a subpixel corresponding to light in a plurality of subpixels of a same color included in each pixel and a subpixel corresponding to shade in the plurality of subpixels of the same color included in each pixel are arranged alternately with each other.

5. The display device according to claim 4, wherein said driving means increases a number of subpixels included in one pixel as the gradation becomes lower.

6. The display device according to claim 5, wherein said driving means increases the number of subpixels included in one pixel by increasing a number of subpixels of at least one color among the subpixels of the respective colors included in the one pixel.

7. A display device comprising:
a panel driven according to a video signal;
a light source configured to emit light for illuminating said panel;
a lens sheet disposed between said panel and said light source; and
driving means for driving said panel;
wherein said lens sheet is formed by arranging a plurality of three-dimensional structures extending on one plane along an extending direction of the plurality of three-dimensional structures,
a width of said three-dimensional structures in an arrangement direction is 110 μm or more, and
said panel has a pixel arrangement such that subpixels of a plurality of colors are arranged so as to form one of a diagonal arrangement, a delta arrangement, and a rectangle arrangement.

8. The display device according to claim 7, wherein the width of said three-dimensional structures in the arrangement direction is 500 μm or less.

9. The display device according to claim 7, wherein said driving means drives said panel such that light and shade occur in a plurality of subpixels of a same color included in one pixel.

10. The display device according to claim 9, wherein said driving means increases a number of subpixels included in one pixel as a gradation becomes lower.

11. The display device according to claim 10, wherein said driving means increases the number of subpixels included in one pixel by increasing a number of subpixels of at least one color among the subpixels of the respective colors included in the one pixel.
